(19) United States
(12) Patent Application Publication
(10) Pub. No.: US 2020/0182434 A1
(43) Pub. Date: Jun. 11, 2020

(54) LIGHT SOURCE MODULE

(71) Applicant: SHARP KABUSHIKI KAISHA, Sakai City, Osaka (JP)

(72) Inventors: TAKATOSHI MORITA, Sakai City (JP); TOSHIO KAGAWA, Sakai City (JP); SHOGO YANASE, Sakai City, Osaka (JP); SHINJI OSAKI, Sakai City, Osaka (JP)

(21) Appl. No.: 16/313,144

(22) PCT Filed: Feb. 2, 2017
(86) PCT No.: PCT/JP2017/003794

§ 371 Date: Dec. 25, 2018

(30) Foreign Application Priority Data
Jun. 28, 2016 (JP) 2016-127960

(51) Int. Cl. F21V 5/00; F21V 7/22; F21S 2/00

(52) U.S. Cl. CPC F21V 5/007; F21S 2/005; F21V 7/22

(57) ABSTRACT

Provided is a light source module that includes: a plurality of light sources (2); a plurality of optical components (a plurality of lenses (3) and a plurality of dichroic mirrors (4)) by which light from the light sources (2) is transmitted; and a housing (10) that accommodates the light sources 2 and the optical components (3) and (4), in which in a state where the plurality of optical components (3) and (4) are respectively fixed to one supporting member (first supporting member (36)) and one supporting member (second supporting member (41)), the supporting members are fixed to the housing (10).

### TECHNICAL FIELD

The present invention relates to a light source module that includes a plurality of light sources, a plurality of optical components that transmit light from the light sources, and a housing that accommodates the light sources and the optical components.

### BACKGROUND ART

In general, in a case where a lens is bonded by using an adhesive member such as ultraviolet (UV) curing resin, the lens may be deviated from an assumed position due to cure shrinkage in UV curing. Particularly in a light source module using a plurality of lasers and micro optical components, deviation in a plane direction perpendicular to light output from the lasers has significant influence on multiplexed light. Accordingly, in a light source module requiring accurate alignment, movement (deviation) of a lens due to the cure shrinkage of an adhesive member needs to be considered.

For example, PTL 1 discloses a light source apparatus that includes a semiconductor laser, a coupling lens by which laser light from the semiconductor laser is converted into a light flux, a laser holder holding the semiconductor laser, and a lens holder which holds the coupling lens and is positioned by photosetting resin in a state of being separated from the laser holder.

Moreover, PTL 2 discloses a laser unit which is constituted by a laser diode (LD) supporting portion that supports a LD, a lens supporting portion that supports a collimator lens, and a slit plate, and which is configured such that the lens supporting portion is fixed after optical axis adjustment between the LD and the collimator lens in an X direction and a Y direction by a fixing portion, and the LD is positioned at a point of action of a holding portion with a connecting part as a fulcrum and an extension end as a power point, so that fine adjustment of a distance between the LD and the collimator lens is performed by adjustment by a screw at the power point.

Moreover, PTL 3 discloses a three-color light source having a structure (refer to [0031], [0032], [0035], [0036], FIG. 2, and the like) in which each of collimator lenses, wavelength filters, and a mirror is fixed on a corresponding sub-base member and the respective sub-base members are mounted on a second main surface of a carrier.

### CITATION LIST

### Patent Literature

PTL 1: Japanese Unexamined Patent Application Publication No. 2008-300591

PTL 1: Japanese Unexamined Patent Application Publication No. 2004-163463

PTL 1: Japanese Unexamined Patent Application Publication No. 2016-15415

### SUMMARY OF INVENTION

### Technical Problem

However, in the light source apparatus described in PTL 1, since one laser includes the laser holder and the lens holder holding the coupling lens, in a case where a plurality of lasers are to be installed in a housing, a plurality of laser holders and a plurality of lens holders also are required to be installed individually, so that there is a problem that a size of the housing increases. Additionally, due to necessity of the individual installation, there is also a problem that takt time required for one housing becomes longer and productivity is lowered.

Moreover, in the laser unit described in PTL 2, adjustment of the collimator lens is performed by moving an optical direction in such a manner that the lens holder is fixed by applying an adhesive and fine adjustment of a supporting member is performed by using the screw. However, such an adjustment method has a problem that in a case where a small module using a plurality lasers is manufactured, lasers having different wavelengths have different appropriate lens positions depending on the respective wavelengths, so that it is difficult to perform adjustment for each of the lasers. Additionally, such an adjustment method also has a problem that productivity is lowered.

Moreover, the three-color light source described in PTL 3 has a structure in which each of the collimator lenses, the wavelength filters, and the mirror is fixed on the corresponding one sub-base member and the respective sub-base members are fixed to the carrier (housing). Additionally, due to necessity of the individual installation, there is also a problem that takt time required for one carrier (housing) becomes longer and productivity is lowered.

The present invention is made in order to solve the problems and an object thereof is to provide a light source module in which a size of the light source module is able to be reduced, takt time when the light source module is manufactured is shorten, and improvement of productivity is achieved. Furthermore, an object thereof is also to provide a light source module in which a plurality of optical components (e.g., a plurality of lenses, a plurality of dichroic mirrors, or the like) are disposed on one supporting member, so that direct transmission of heat from a housing is suppressed and influence of heat sagging caused by heat on an adhesive member which fixes the optical components is reduced, achieving improvement of quality and reliability.

### Solution to Problem

In order to solve the problems, a light source module of the invention includes: a plurality of light sources; a plurality of optical components by which light from the light sources is transmitted; and a housing that accommodates the light sources and the optical components, in which in a state where the plurality of optical components are fixed to one supporting member, the supporting member is fixed to the housing.

Moreover, according to the light source module of the invention, a configuration in which in a case where the plurality of optical components are a plurality of lenses, the plurality of lenses or a plurality of lens holders that hold the plurality of lenses are fixed to the supporting member may be provided.

Moreover, according to the light source module of the invention, a configuration in which the plurality of lenses or the plurality of lens holders have surfaces, which are vertical to optical axis directions of the plurality of light sources, fixed to the supporting member may be provided.

Moreover, according to the light source module of the invention, a configuration in which the supporting member includes a plurality of apertures may be provided.

Moreover, according to the light source module of the invention, a configuration in which the supporting member includes a hole, a groove, or a protrusion between the plurality of apertures may be provided.

Moreover, according to the light source module of the invention, a configuration in which the supporting member is substantially vertically fixed to the housing may be provided.

Moreover, according to the light source module of the invention, a configuration in which in a case where the plurality of optical components are a plurality of dichroic mirrors, a fixed surface of the supporting member forms a gap with the housing may be provided.

Moreover, according to the light source module of the invention, a configuration in which heat conductivity of the supporting member is lower than heat conductivity of the housing may be provided.

Moreover, according to the light source module of the invention, a configuration in which the supporting member has a structure to be formed of an antireflection material or a black material and have a surface subjected to microfabrication may be provided.

### Advantageous Effects of Invention

According to the invention, a plurality of optical components are disposed on one supporting member and adjusted and the supporting member after the adjustment is fixed to a housing, so that it is possible to improve productivity of a light source module. Additionally, the plurality of optical components (e.g., a plurality of lenses or a plurality of dichroic mirrors) are disposed on one supporting member, so that it is possible to suppress direct transmission of heat from a housing and to reduce influence of heat sagging caused by heat on an adhesive member which fixes the optical components. Further, by using a supporting member having an opening (aperture) that is vertically disposed with respect to an optical axis direction, a shape of a beam is able to be adjusted.

Furthermore, an active alignment method is adaptable to bond a lens holder, so that it is possible to expand an acceptable range of deviation due to alignment.

### BRIEF DESCRIPTION OF DRAWINGS

FIG. 1 is a perspective view of a light source module according to Embodiment 1 of the invention when viewed obliquely downward.

FIG. 2 is a plan view of the light source module according to Embodiment 1 of the invention.

FIG. 3 is a sectional view taken along a line A-A of FIG. 2.

FIG. 4 is a sectional view taken along a line B-B of FIG. 2.

FIG. 5 is a sectional view taken along a line C-C of FIG. 2.

FIG. 6 is a perspective view of a lens holder.

FIG. 7 is a front view of a first supporting member according to Embodiment 2 when viewed from a dichroic mirror side.

FIG. 8A is a sectional view taken along a line D-D of FIG. 7.

FIG. 8B is a sectional view taken along the line D-D of FIG. 7.

FIG. 9 is a schematic plan view illustrating a configuration of a light source module according to Embodiment 3.

FIG. 10 is a sectional view taken along a line E-E of FIG. 9.

FIG. 11 is a sectional view illustrating another bonding structure between a second supporting member and a bottom surface of a housing according to Embodiment 4.

FIG. 12 is a schematic plan view of the housing in which illustration of lasers, lenses, and dichroic mirrors is omitted.

FIG. 13A is a schematic plan view illustrating one of various kinds of modification examples of the bonding structure between the second supporting member and the bottom surface of the housing.

FIG. 13B is a schematic plan view illustrating one of various kinds of the modification examples of the bonding structure between the second supporting member and the bottom surface of the housing.

FIG. 13C is a schematic plan view illustrating one of various kinds of the modification examples of the bonding structure between the second supporting member and the bottom surface of the housing.

FIG. 13D is a schematic plan view illustrating one of various kinds of the modification examples of the bonding structure between the second supporting member and the bottom surface of the housing.

### DESCRIPTION OF EMBODIMENTS

Hereinafter, embodiments of the invention will be described with reference to drawings.

### Embodiment 1

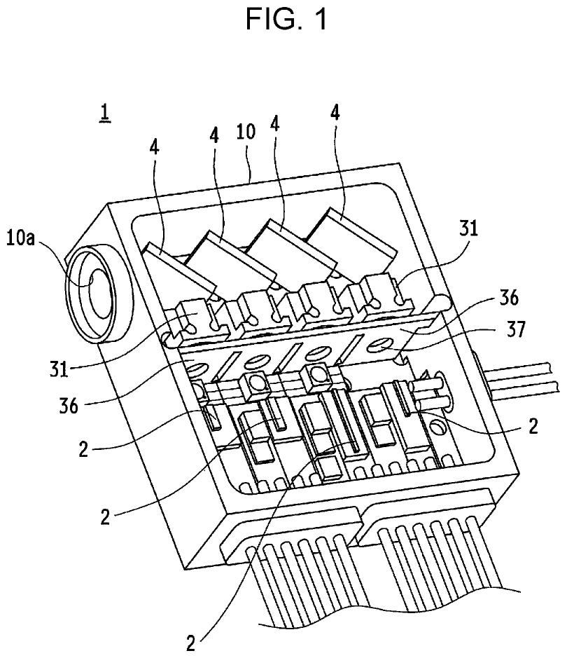

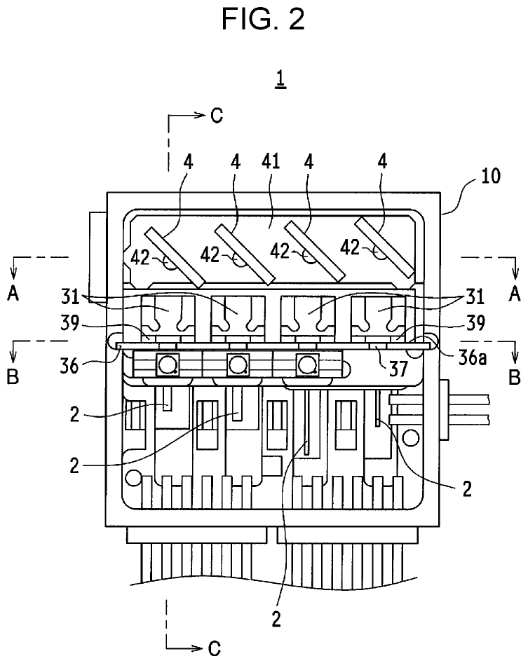

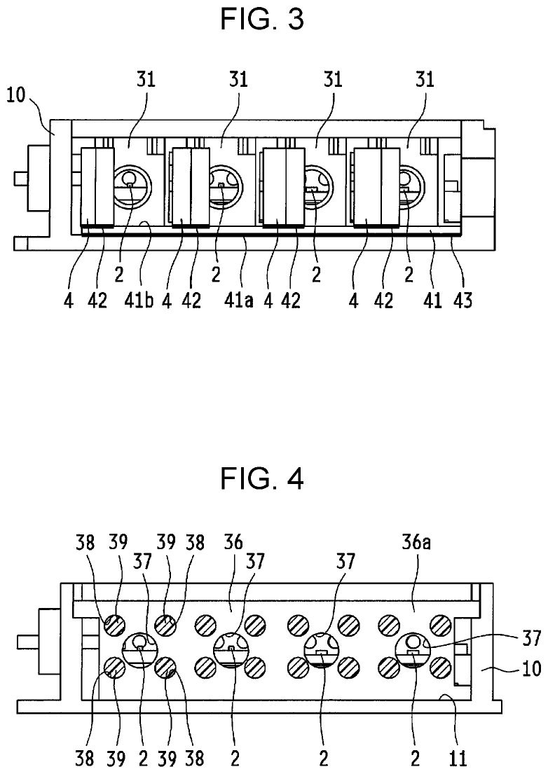

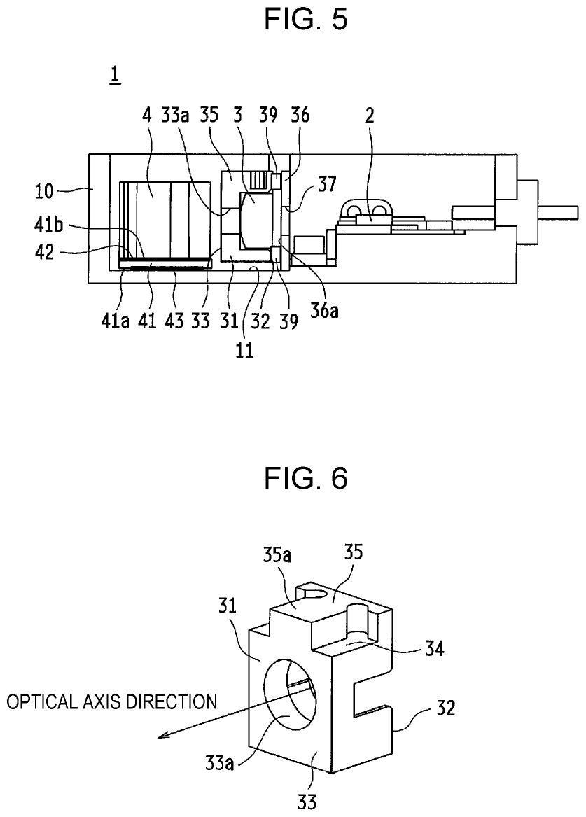

FIG. 1 is a perspective view of a light source module according to Embodiment 1 of the invention when viewed obliquely downward, FIG. 2 is a plan view of the light source module according to Embodiment 1 of the invention, FIG. 3 is a sectional view taken along a line A-A of FIG. 2, FIG. 4 is a sectional view taken along a line B-B of FIG. 2, FIG. 5 is a sectional view taken along a line C-C of FIG. 2, and FIG. 6 is a perspective view of a lens holder.

A light source module 1 of the invention is configured by including lasers (LDs) 2 serving as a plurality of (in Embodiment 1, four) light sources, four lenses 3 (refer to FIG. 5) that transmit light from the lasers 2, four dichroic mirrors 4 that reflect light transmitted through the four lenses 3 in the same direction to multiplex the light, and a housing 10 that accommodates the lasers 2, the lenses 3, and the dichroic mirrors 4.

The housing 10 is formed into a box which has a rectangular shape in plan view, a top of which is opened, and, the lenses 3 and the dichroic mirrors 4 are mounted and fixed on a bottom surface 11 of the housing 10 through supporting members described below.

### (Explanation of Installation Structure of Lens 3)

Each of the lenses 3 (refer to FIG. 5 and the like) that is formed into a lateral short columnar shape is held by a lens holder 31. The lens holder 31 is formed into a box in a rectangular shape in which a side of a rear surface 32 (right side in FIG. 5 or 6) which faces the laser 2 serves as an opening holding portion into which the lens 3 is inserted and held and a light output port 33a in a round shape along an optical axis direction is provided on a side of a front surface 33 from which light is output. On an upper surface 34, a chucking portion 35 that includes a projected portion 35a capable of chucking and conveying the lens holder 31 by a chucking jig that is not illustrated is formed.

Each of the lens holders 31 formed in this manner is mounted in a state of being bonded and fixed on one surface (that is, a surface opposite to a surface facing the laser 2) 36a of a first supporting member 36 that is a laterally elongated plate body, and the first supporting member 36 is fixed on the bottom surface 11 of the housing 10.

That is, the first supporting member 36 is fixed so as to substantially vertically stand on the bottom surface 11 of the housing 10 with one of long sides being down. Accordingly, the lens holders 31 that hold the respective lenses 3 are held in the housing 10 so as to face the lasers 2 in a state of being disposed side by side in a lateral direction.

Moreover, in Embodiment 1, four openings 37 each of which has an aperture function are provided in the first supporting member 36 so as to face the respective lasers 2.

Note that, though a configuration in which the supporting member 36 stands on the bottom surface 11 of the housing 10 is provided in Embodiment 1, a supporting member having a plate shape and is not self-standing is not always required to be fixed in a stand state, and a supporting member having a self-standing shape may be disposed in the housing. As described below, it is only required that fixing is performed in such a manner that a direction in which the supporting member and the housing are fixed is substantially vertical to a direction in which the lens holder and the supporting member are fixed, that is, the fixing may be performed in a mode in which an effect of the invention is able to be obtained.

Furthermore, the fixing in an substantially vertical manner is not required to be performed completely vertically, and may be performed vertically to such an extent that the lens is properly disposed within an allowance range in an X direction, a Y direction, a Z direction, an X-axis direction, a Y-axis direction, and a Z-axis direction, with respect to an optical axis of laser light. That is, the fixation is only required to be performed vertically to an extent that an effect of the invention is achieved.

Here, the lens holders 31 are bonded and fixed on the one surface 36a of the first supporting member 36 by adhesive members 39 that are made of an adhesive, for example, such as ultraviolet (UV) curing resin or photosetting resin. Specifically, as illustrated in FIGS. 2, 4, 5, and the like, the adhesive members 39 are applied in a columnar shape to four places around an opening 37 and the lens holders 31 are bonded and fixed on the one surface 36a of the first supporting member 36 with the adhesive members 39 as support columns. That is, each of the lens holders 31 is bonded and fixed on the surface of the first supporting member 36, which is vertical to the optical axis directions of the lasers 2. Note that, it is desirable that four support columns by the adhesive members 39 are used for supporting, but a purpose is just three-dimensional fixing by the active alignment method and a shape of each of the support columns and the number of support columns are not particularly limited. For example, a case where adjacent support columns adhere to each other may be acceptable. In short, the shape of the support column is not particularly limited as long as the adhesive member 39 does not interfere with light output from the opening 37. Additionally, in Embodiment 1, the bonding and fixing are performed by using the lens holder 31, but the bonding and fixing may be performed only by the lens 3 without using the lens holder 31. In this case, a lens with a square outer diameter rather than a lens in a round shape is preferably used as the lens 3. For a lens whose outer shape is square, it is possible to apply the adhesive to a vicinity of the outer diameter, which is not an effective diameter of the lens.

In this case, on the one surface 36a of the first supporting member 36, adhesive recesses 38 (refer to FIG. 4) that serve as marks for application of the adhesive members 39 may be formed at the four places around the opening 37. Each of the adhesive recess 38 is formed into a round shape in plan view and a shape thereof in a depth direction may be, for example, a cylindrical recess or a conical recess. Moreover, the adhesive recess 38 may have another shape as long as the adhesive member 39 is easily applied. In this manner, by providing the adhesive recess 38 at a position where the adhesive member 39 is applied, it is possible to utilize the adhesive recess 38 for preventing lateral spreading of the adhesive member 39 that is applied or for controlling an amount of the application, for example.

### (Explanation of Installation Structure of Dichroic Mirror 4)

In a state where the respective dichroic mirrors 4 disposed on a front side of the respective lenses 3 in the optical axis direction are fixed on a second supporting member 41 that is a laterally elongated plate body, the second supporting member 41 is fixed on the bottom surface 11 of the housing 10. That is, as illustrated in FIG. 3, 5 and the like, the second supporting member 41 is placed in such a manner that one surface (hereinafter, referred to as a lower surface) 41a fits the bottom surface 11 of the housing 10, and is bonded and fixed by applying an adhesive member 43 to the entire lower surface 41a of the second supporting member 41 or the entire bottom surface 11 of the housing 10 which faces the lower surface 41a of the second supporting member 41. On an upper surface 41b of the second supporting member 41, the dichroic mirrors 4 are disposed to vertically stand with a predetermined reflection angle (45° in this example) with respect to the optical axis direction, and are bonded and fixed by an adhesive member 42 that is made of an adhesive, for example, such as ultraviolet (UV) curing resin or photosetting resin. However, the adhesive is not limited to the adhesive member made of ultraviolet curing resin or photosetting resin.

Note that, the adhesive member 43 is not also particularly limited, but it is preferable to use an adhesive member similar to the adhesive member 42.

In the structure described above, the light source module 1 according to Embodiment 1 is a small module in which the housing 10 has a dimension of, for example, approximately 10 mm in length, 10 mm in width, and 3 mm in thickness. In the small housing 10, the lenses 3 and the dichroic mirrors 4, the number of each of which corresponds to the number of the lasers 2, are respectively fixed to one supporting member (the first supporting member 36) and one supporting member (the second supporting member 41).

In this case, the respective lasers 2 may be lasers having different wavelengths or a plurality of lasers having different wavelengths and a plurality of lasers having the same wavelength may be mixed to be used.

For example, four kinds of lasers of a blue laser having a wavelength of 450 nm, a green laser having a wavelength of 520 nm, a red laser having a wavelength of 638 nm, and an infrared laser having a wavelength of 850 nm may be used, or three kinds of lasers of a blue laser having a wavelength of 450 nm, a green laser having a wavelength of 520 nm, a red laser having a wavelength of 638 nm, and further a red laser having the same wavelength of 638 nm may be used. When the infrared laser is used for the four kinds of lasers (RGB+IR lasers), it is possible to achieve a ranging sensor capable of measuring a distance, an application that responds to a motion gesture, or the like, so that a use range is expanded. Additionally, in a case where lasers of one kind in the three kinds of lasers have the same wavelength, luminance is increased, thus making it possible to achieve a laser light module with high output. Note that, the four lasers in four kinds of blue, green, red, and infrared lasers, or the four lasers in three kinds of blue, green, red, and red lasers are exemplified in the aforementioned example, but, in addition to the above, it is also possible to combine various kinds and various number of lasers, for example, such as a combination of six lasers in four kinds of red, red, green, green, blue, and infrared lasers.

Light (laser light) output from each of the lasers 2 passes through the opening 37 that is opened in the first supporting member 36. As described above, the opening 37 also has the aperture function by which an effect of adjusting a form of a beam of the laser light is expected. Accordingly, a condition of a diameter of the opening 37 is to be smaller than or equal to a diameter of the lens 3.

Moreover, it is preferable that a material of the first supporting member 36 has heat conductivity lower than that of the housing 10. For example, in a case where the material of the housing 10 is brass, it is preferable that a stainless steel (for example, SUS302 or the like) or the like that has heat conductivity lower than that of the brass is used as the material of the first supporting member 36. Additionally, it is more preferable that a material, such as resin, which has much lower heat conductivity is used as the first supporting member 36.

The laser light that has passed through the openings 37 of the first supporting member 36 is incident on the lenses (collimator lenses) 3 to become parallel light.

As described above, in a state where the lenses 3 are held by the lens holders 31, the lens holders 31 are bonded and fixed to the first supporting member 36 by the adhesive members 39 such as ultraviolet (UV) curing resin or photosetting resin. That is, the adhesive members 39 are applied in a columnar shape to the four places around each of the openings 37 and the respective lens holders 31 are bonded and fixed on the one surface 36a of the first supporting member 36 with the adhesive members 39 as support columns by the active alignment method. Here, the active alignment method is a method in which alignment is performed in a state where the adhesive members 39 are applied to the lens holder 31 or the first supporting member 36, the lens holder 31 and the first supporting member 36 are made close to each other when a desired spot diameter, a desired angle, and the like are obtained to bring a state where the adhesive members 39 serve as support columns, and then, the adhesive members 39 are cured by, for example, irradiation with an ultraviolet (UV) ray, so that the lens holders 31 are three-dimensionally fixed.

In order to reduce a size of the light source module 1, it is necessary to perform adjustment by using a small lens as the lens 3, but, when a size of the lens 3 is reduced, handling becomes hard and an effective diameter of the lens becomes small, resulting in that efficiency is lowered. Furthermore, in a case where a focal distance is shortened for obtaining a desired spot diameter, slight deviation of the lens has great influence on performance.

In this case, when a desired spot is intended to be obtained at a focal distance of 1.5 m by using, for example, a lens having a certain curvature radius, an acceptable range in a direction of a Z axis along the optical axis direction is several tens of micrometers, whereas an acceptable range in a direction of an X axis or a Y axis orthogonal to the optical axis is approximately several micrometers. An acceptable difference in the direction of the Z axis is expected to be approximately 10 times larger than an acceptable difference in the direction of the X axis or the Y axis. Accordingly, it is preferable that the active alignment method is used for the bonding and fixing of the lens holder 31 to the first supporting member 36. That is, first, adjustment is performed in the directions of the X axis and Y axis and performed in the direction of the Z axis, and thereafter, the bonding and fixing are performed by applying the adhesive members 39 in a columnar shape. Accordingly, it is preferable that the adhesive members 39 that are used have a low cure shrinkage rate. It is preferable that the cure shrinkage rate is, for example, 5.0% or less.

Moreover, the ultraviolet (UV) curing resin or the photosetting resin used as the adhesive members 39 may have a small total outgas amount after curing. For example, it is preferable that the total outgas amount is 20000 ppm to 1 ppm.

Next, the laser light that has passed through the respective lenses (collimator lenses) 3 held by the first supporting member 36 in the aforementioned manner is reflected in a predetermined direction by the dichroic mirrors 4 disposed opposite to the lenses 3 in the optical axis direction, and is multiplexed and output from an output port 10a (refer to FIG. 1) formed on a side of the housing 10.

Each of the dichroic mirrors 4 is a wavelength-selective filter by which laser light is transmitted and reflected in accordance with a wavelength of the laser light and is a wavelength filter by which laser light having a certain wavelength is reflected and laser light having another wavelength is transmitted. Alternatively, the dichroic mirror 4 is a wavelength filter by which laser light having a certain wavelength is transmitted and laser light having another wavelength is reflected.

As described above, the dichroic mirrors 4 are characterized by being fixed to one second supporting member 41. A material having heat conductivity lower than that of the housing 10 is preferably used as the second supporting member 41, similarly to the first supporting member 36.

Moreover, as a method of fixing the second supporting member 41 to the bottom surface 11 of the housing 10, any fixing method may be used as long as the fixing is firmly performed, but in a case where the bonding and fixing are performed by the adhesive member 43, an adhesive material made of the ultraviolet (UV) curing resin or the photosetting resin is preferably used. In particular, in a case where the ultraviolet (UV) curing resin is used, UV curing resin whose total outgas amount after UV curing is 20000 ppm to 1 ppm is preferably used. Furthermore, an adhesive material having a low cure shrinkage rate is preferably used, and it is preferable that the cure shrinkage rate is, for example, 5.0% or less.

Alignment of the dichroic mirrors 4 may be performed in the housing 10, but, it is preferable that the fixing in the housing 10 is performed after alignment of the second supporting member 41 and the dichroic mirrors 4 is performed outside (before being accommodated in the housing 10), because good operability (workability) is achieved. That is, the dichroic mirrors 4 are aligned with respect to the second supporting member 41 and then the second supporting member 41 is fixed to the housing 10 as a package.

Moreover, the first supporting member 36 and the second supporting member 41 are preferably formed of an antireflection material or a black material. Additionally, a configuration in which a surface is subjected to microfabrication (for example, roughened matt process or the like) may be provided. As the antireflection material or the black material, a commercially available light shielding/antireflection black film or a film obtained through which high-functional blackening treatment is applied is able to be used, for example. According to the configuration, it is possible to enhance an effect of preventing stray light.

### (Conclusion of Embodiment 1)

The light source module 1 according to Embodiment 1 includes the plurality of lasers (LD) 2, the lenses 3, and the dichroic mirrors 4, and has one feature that when the lenses 3 and the dichroic mirrors 4 are fixed to the housing 10, the fixing is performed with the first supporting member 36 and the second supporting member 41 interposed therebetween. The lens holders 31 with the lenses 3 mounted thereon and the dichroic mirrors 4 are fixed in the housing 10 by the adhesive material, and the bonding and fixing to the housing 10 is performed with the first supporting member 36 and the second supporting member 41 interposed therebetween, so that it is possible to suppress influence of heat on the lenses 3 or on the dichroic mirrors 4 as much as possible.

Moreover, the plurality of dichroic mirrors 4 are mounted on the second supporting member 41 and the second supporting member 41 is then installed in the housing 10, so that it is possible to shorten process time (takt time) compared with a case where the plurality of the dichroic mirror 4 are individually installed in the housing 10. For example, when it takes 10 seconds to directly install one dichroic mirror 4 in the housing 10 and a time interval between installation of another dichroic mirror 4 and installation of still another dichroic mirror 4 is 5 seconds, approximately 55 (=10×4+5×3) seconds are required to install four dichroic mirrors 4. On the other hand, when the four dichroic mirrors 4 are bonded and fixed to the second supporting member 41 in advance (that is, in another process), it takes approximately 10 seconds to install the second supporting member 41 in the housing 10, the time being substantially the same as the time to install one dichroic mirror 4. That is, process time to install the dichroic mirrors 4 is able to be shortened by approximately 45 seconds so that production efficiency is also improved.

The chucking portion 35 formed on the upper surface 34 of the lens holder 31 is formed in narrow width so that the projected portion 35a is able to be held from right and left directions that are orthogonal to the optical axis direction. Thus, even when the projected portion 35a is held from both sides by a claw of a chucking jig, it is possible to secure sufficient clearance without contacting an adjacent lens holder 31.

### Embodiment 2

The light source module 1 according to Embodiment 1 has a configuration in which the first supporting member 36 has the four openings 37 disposed in a row at predetermined intervals on a plate body that is formed to be elongated laterally. In a case where the lens holders 31 are bonded and fixed, the adhesive members 39 are applied in a columnar shape to four places around each of the openings 37, the lens holders 31 are bonded and fixed to the first supporting member 36 with the adhesive members 39 as support columns. In this case, since adjacent openings 37 are relatively close to each other, the adhesive members 39 that are applied around each of the openings 37 are also extremely close to each other. Accordingly, there is a possibility that the adhesive member 39 applied around one of the openings 37 is dropped so as to spread to a side of the other adjacent opening 37 and interference with the adjacent opening 37.

Then, Embodiment 2 is designed to prevent the adhesive member 39 from dropping to and interfering with the adjacent opening 37.

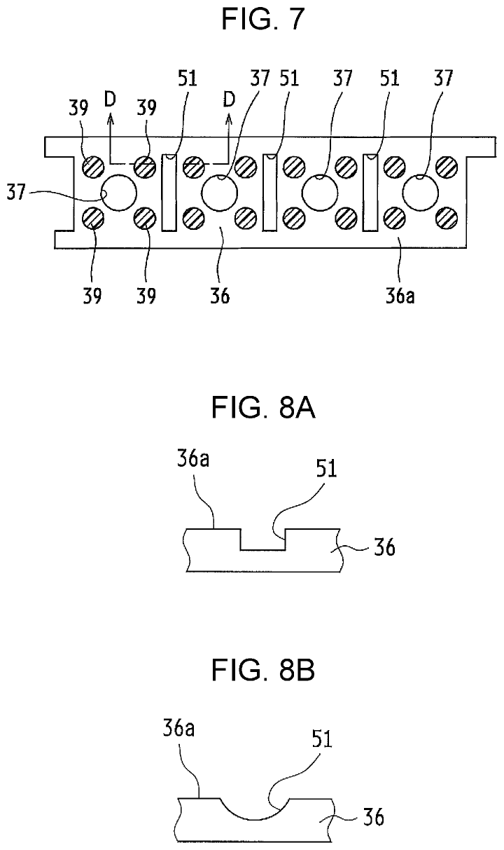

FIG. 7 is a front view of a first supporting member 36 according to Embodiment 2 when viewed from a dichroic mirror 4 side. FIGS. 8A and 8B are sectional views taken along a line D-D of FIG. 7.

The first supporting member 36 according to Embodiment 2 is one in which a regulating portion 51 that regulates a flow (spread) of the adhesive member 39 in a lateral direction is provided between the openings 37 disposed laterally in a row.

The regulating portion 51 is a longitudinally long recessed groove or a longitudinally long through hole (slit), which is formed between the openings 37 adjacent to each other, and a sectional shape in a case of the recessed groove may be, for example, a simple recessed shape as illustrated in FIG. 8A, a substantially U-shape (or a substantially V-shape) as illustrated in FIG. 8B, or the like. Moreover, the regulating portion 51 also enables to regulate a flow (spread) of the adhesive member 39 in the lateral direction by providing a protrusion between the openings 37.

In this manner, by providing the regulating portion 51 between the openings 37 adjacent to each other, even when the adhesive member 39 applied around one of the openings 37 is dropped so as to spread to the side of the adjacent opening 37, the regulating portion 51 regulates the spread so that interference is prevented from occurring.

### Embodiment 3

In Embodiment 1, the plurality of dichroic mirrors 4 are bonded and fixed to the second supporting member 41 while positions thereof are individually adjusted, and after that, the second supporting member 41 is bonded and fixed to the bottom surface 11 of the housing 10. Thereby, the process time to install the dichroic mirrors 4 is shortened as described above. However, time (time to perform an operation as another process) to bond and fix the plurality of dichroic mirrors 4 to the second supporting member 41 while positions thereof are adjusted is not considered in the aforementioned process, so that the adjustment time is also added, and therefore, the process time is not greatly shortened.

Then, Embodiment 3 is designed for replacement of the dichroic mirrors 4 in order to shorten the time to bond and fix the plurality of dichroic mirrors 4 to the second supporting member 41 while adjusting positions thereof.

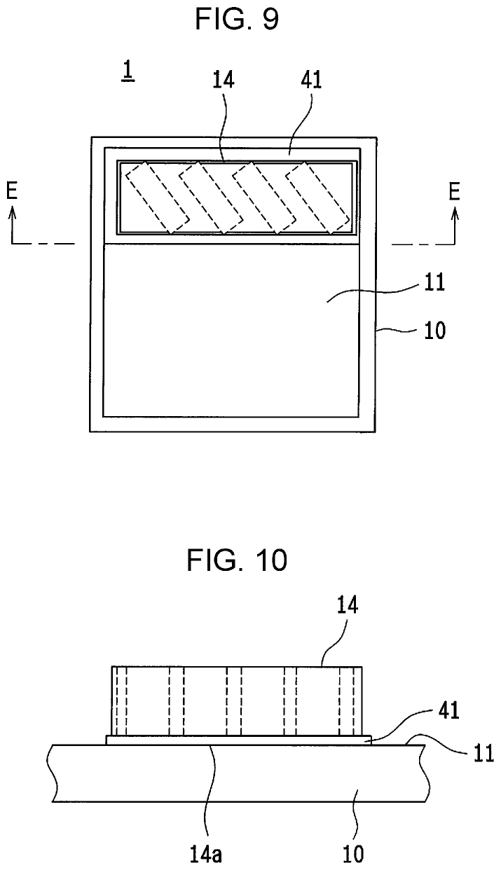

FIG. 9 is a schematic plan view illustrating a configuration of a light source module 1 according to Embodiment 3 and FIG. 10 is a sectional view taken along a line E-E of FIG. 9. Note that, illustration of the laser 2, the lens holder 31, and the like is omitted in FIG. 9.

In the light source module 1 according to Embodiment 3, a composite prism 14 obtained by combining properties of wavelength filters corresponding the plurality of dichroic mirrors 4 by one prism is prepared instead of individually using the plurality of dichroic mirrors 4, and the composite prism 14 is placed on the second supporting member 41 to be bonded and fixed.

That is, a structure in which a bottom surface 14a of the composite prism 14 is bonded and fixed to the second supporting member 41 is provided. In this case, all mirror angles of the composite prism are the same.

In this manner, the composite prism 14 obtained by combining the individual properties of the wavelength filters by one prism is used so that time to individually adjust the positions of the dichroic mirrors 4 is able to be shortened and production efficiency is able to be improved.

### Embodiment 4

In Embodiment 1, a structure in which the second supporting member 41 that supports the dichroic mirrors 4 is placed so that the lower surface 41a fits the bottom surface 11 of the housing 10, and by applying the adhesive member 43 to the entire lower surface 41a of the second supporting material 41 or to the entire bottom surface 11 of the housing 10, which faces the lower surface 41a of the second supporting material 41, the bonding and fixing are performed is provided. That is, the structure in which the entire lower surface 41a of the second supporting member 41 contacts the bottom surface 11 of the housing 10 (a structure in which a contact area is wide) is provided. Thus, the structure is such that heat is easy to be transmitted from a side of the housing 10 to the second supporting member 41.

Then, Embodiment 4 is designed for a bonding structure between the second supporting member 41 and the bottom surface 11 of the housing 10.

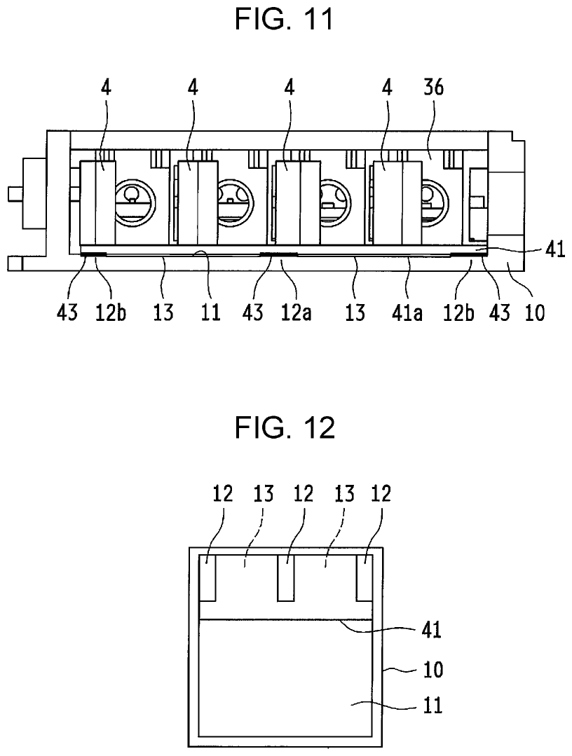

FIG. 11 is a sectional view illustrating another bonding structure between the second supporting member 41 and the bottom surface 11 of the housing 10 according to Embodiment 4, and corresponds to a sectional view taken along the line A-A of FIG. 2. FIG. 12 is a schematic plan view of the housing 10 in which illustration of the laser 2, the lens 3, and the dichroic mirror 4 is omitted. Note that, in FIG. 12, the housing 10 is illustrated as transparently seen from an upper side.

That is, in Embodiment 4, a structure in which a plurality of protrusions 12 are provided on the bottom surface 11 of the housing 10, which faces the lower surface 41a of the second supporting member 41, the lower surface 41a of the second supporting member 41 is placed on the protrusions 12, the protrusions 12 and the lower surface 41a of the second supporting member 41 are bonded and fixed by the adhesive member 43 therebetween is provided. Note that, in Embodiment 4, the protrusions 12 are provided at three places in a center part and both right and left sides. According to the structure, it is possible to reduce a contact area of the bottom surface 11 of the housing 10 and the lower surface 41a of the second supporting member 41 and a gap 13 between adjacent protrusions 12 is formed between the lower surface 41a of the second supporting member 41 and the bottom surface 11 of the housing 10. Thereby, a structure in which heat is hard to be transmitted is provided and a heat insulation effect is able to be expected.

Accordingly, it is possible to reduce the influence of heat on the dichroic mirrors 4 when the dichroic mirrors 4 are bonded and fixed to the second supporting member 41 by UV curing or photosetting. Moreover, it is also possible to suppress influence of heat on the adhesive member 43, thus making it possible to suppress positional deviation of the dichroic mirror 4 due to heat sagging.

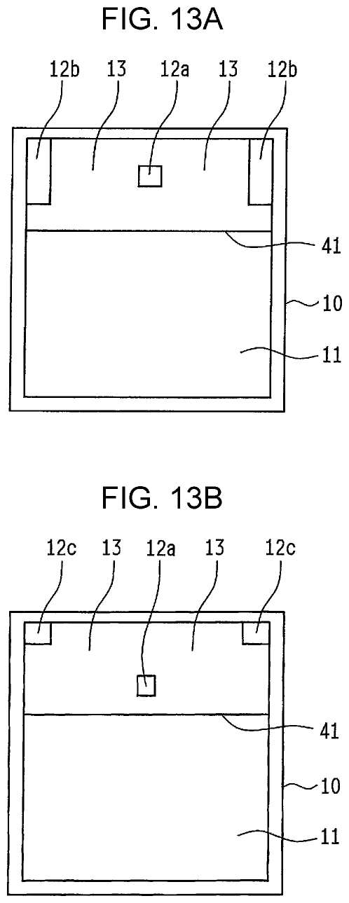

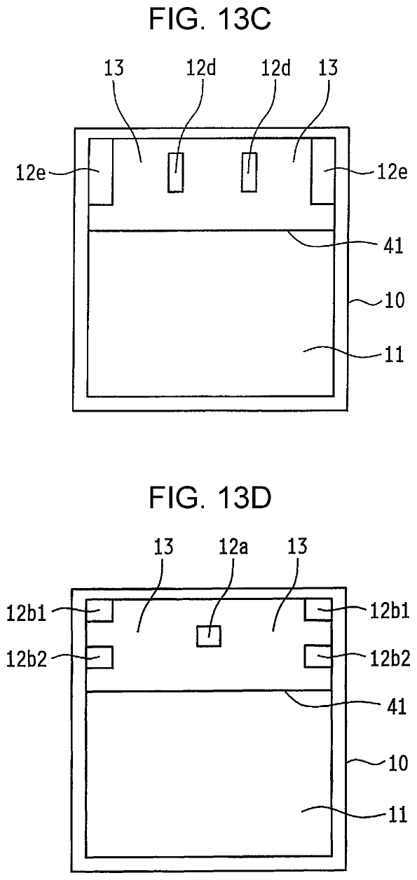

FIGS. 13A through 13D illustrate various kinds of modification examples of the bonding structure between the second supporting member 41 and the bottom surface 11 of the housing 10.

FIG. 13A illustrates the same protrusions 12 as those of FIG. 12 in that the number of protrusions is three, but a protrusion 12a in a center part has a length shorter than those of protrusions 12b on both sides and has an island-like shape in FIG. 13A.

Furthermore, FIG. 13B is a further modification example of FIG. 13A and provides an arrangement structure in which protrusions 12c on both right and left sides also have short lengths and support in a triangle shape is achieved by just three protrusions 12a, 12c, and 12c.

Moreover, in FIG. 13C, four protrusions in total are provided so as to be positioned at two places of the right and left of the center part and both right and left ends. Each of two protrusions 12d in the center part has a length shorter than those of protrusions 12e on both right and left sides and has an island-like shape.

Furthermore, FIG. 13D is a modification example of FIG. 13A and provides an arrangement structure in which each of the protrusions 12b on the both right and left sides is divided into two (12b1 and 12b2) on front and rear sides and support in a cross shape is performed by five protrusions of the protrusion 12a in the center part, two front and rear protrusions 12b1 and 12b2 on the right side, and two front and rear protrusions 12b1 and 12b2 on the left side.

Note that, each of the modification examples of the bonding structures illustrated FIGS. 13A through 13D is merely an example, and an arrangement structure of protrusions is not limited to such arrangement structures.

The invention is able to be implemented in other various forms without departing from a spirit thereof and a main feature thereof. Therefore, any of the embodiments described above is merely an example in all respects and should not be constructed as limitative. The scope of the invention is indicated by the scope of the claims and is not restricted in any way by the text of the specification. Moreover, all variation and modification falling within a scope equivalent to the scope of the claims are included in the scope of the invention.

Note that, this application claims the benefit of priority to Japanese Patent Application No. 2016-127960 filed on Jun. 28, 2016, the content of which is incorporated herein by reference in its entirety. Furthermore, the entire contents of a reference cited in the present specification are herein specifically incorporated by reference.

### INDUSTRIAL APPLICABILITY

The light source module of the invention is able to be suitably used for a light beam scanning optical system used for an image forming apparatus such as a digital copying machine or a laser printer, an image displaying apparatus using a light source with storing directivity such as laser light, a small projector and a pico-projector, smart glasses and a head mound display that serve as a wearable terminal, an illumination apparatus having means of equalizing a light flux, and the like.

### REFERENCE SIGNS LIST

1 light source module
2 laser (light source)
3 lens (collimator lens)
4 dichroic mirror
10 housing
10a output port
11 bottom surface
12 (12a to 12e) protrusion
13 gap
14 composite prism
14a bottom surface
31 lens holder
32 rear surface
33 front surface
33a light output port
34 upper surface
35 chucking portion
36 first supporting member (supporting member)
36a one surface
37 opening (aperture)
38 adhesive recess
39 adhesive member
41 second supporting member (supporting member)
41a one surface (lower surface)
41b upper surface
43 adhesive member
51 regulating portion

1. A light source module comprising:
a plurality of light sources;
a plurality of optical components by which light from the light sources is transmitted; and
a housing that accommodates the light sources and the optical components, wherein
in a state where the plurality of optical components are fixed to one supporting member, the first supporting member is fixed to the housing,
the plurality of optical components are a plurality of lenses, and
the first supporting member has a plate shape and is fixed in the housing so as to substantially vertically stand on a bottom surface of the housing with one side of the first supporting member being down.

2. (canceled)

3. The light source module according to claim 1, wherein
the plurality of lenses or a plurality of lens holders that hold the plurality of lenses are fixed to the supporting member.

4. The light source module according to claim 3, wherein
the plurality of lenses or the plurality of lens holders have surfaces, which are vertical to optical axis directions of the plurality of light sources, fixed to the supporting member.

5. The light source module according to claim 1, wherein
the supporting member includes a plurality of apertures.

6. The light source module according to claim 5, wherein
the supporting member includes a hole, a groove, or a protrusion between the plurality of apertures.

7. (canceled)

8. The light source module according to claim 1, further comprising
a plurality of dichroic mirrors.

9. The light source module according to claim 8, further comprising
a second supporting member that supports the plurality of dichroic mirrors, wherein
in a state where the plurality of dichroic mirrors are fixed to the second supporting member, the second supporting member is fixed to the housing, and
a fixed surface of the second supporting member forms a gap with the housing.

10. The light source module according to claim 1, wherein
heat conductivity of the supporting member is lower than heat conductivity of the housing.

11. The light source module according to claim 1, wherein
the supporting member has a structure to be formed of an antireflection material or a black material and have a surface subjected to microfabrication.
